(19) United States
(12) Patent Application Publication
(10) Pub. No.: US 2026/0193512 A1
(43) Pub. Date: Jul. 9, 2026

(54) EMULSIONS THAT INCLUDE PYRIDINIUM-BASED COMPOUNDS AND USES THEREOF

(71) Applicant: Saudi Arabian Oil Company, Dhahran (SA)

(72) Inventors: Muhammad Imran Ul-Haq, Dhahran (SA); Mohammad Shoaib, Dhahran (SA)

(73) Assignee: Saudi Arabian Oil Company, Dhahran (SA)

(21) Appl. No.: 19/014,078

(22) Filed: Jan. 8, 2025

(51) Int. Cl. C09K 8/28

(52) U.S. Cl. CPC C09K 8/28

(57) ABSTRACT

Emulsions that include a pyridinium-based compound functionalized by including a heteroatom substituents containing at least one oxygen, nitrogen, or sulfur atoms are provided. Also provided are methods for extracting hydrocarbons in a downhole environment utilizing such emulsions. Also provided are methods for transporting hydrocarbons in a pipeline utilizing such emulsions. Also provided are methods for cleaning a tank housing hydrocarbons utilizing such emulsions.

### TECHNICAL FIELD

The present disclosure relates to chemical mixtures and, more specifically, to emulsions.

### BACKGROUND

Emulsions are mixtures of two immiscible liquids; however, due to the high interfacial tension between the two immiscible liquids, emulsification of one liquid in another is energetically less favored and the emulsions formed tend to be unstable and separate quickly. The interfacial tension can be reduced by emulsifiers, and therefore emulsifiers are often included to formulate and stabilize the emulsions. As emulsions may be utilized in a wide variety of technologies, including the petroleum industry, new emulsion chemical mixtures that include new emulsifiers are desired by industry.

### SUMMARY

Described herein are emulsions that include pyridinium-based compounds as emulsifiers, and methods for using such emulsions. Such emulsions may include a pyridinium-based compound, where the nitrogen atom of the pyridinium is further functionalized by including a group that includes at least one additional nitrogen atom, oxygen atom, or sulfur atom, or combinations thereof, as is described herein. The emulsions and/or the emulsifiers may be utilized, for example, in methods for extracting hydrocarbons in a downhole environment, transporting hydrocarbons in a pipeline, or cleaning tanks that house hydrocarbons. Such emulsions and/or emulsifiers may have relatively good stability as compared to conventional emulsions and/or emulsifiers.

According to one or more embodiments of the present disclosure, an emulsion may comprise an aqueous phase comprising an aqueous base fluid, a non-aqueous phase comprising hydrocarbons, and an emulsifier that is a pyridinium-based compound having the structure according to Chemical Structure #1 or a salt thereof. In Chemical Structure #1, X may be —CH₃, —OH, —NH₂, or —SH, and Y may be —CH₂—, —O—, —NR²—, or —S—, excluding where X is —CH₃ and Y is —CH₂—. Furthermore, R¹ may be a C₁-C₁₈ alkyl group, a C₁-C₁₈ hydroxyl alkyl group, a C₁-C₁₈ alkenyl group, a C₁-C₁₈ internal alkynyl group, a C₁-C₁₈ acryl group, a C₁-C₁₈ cycloalkyl group, or a C₁-C₁₈ functional alkyl group; and each of R², R_{A}, R_{B}, R_{C}, R_{D}, and R_{E} may be chosen from hydrogen, a C₁-C₁₈ alkyl group, a C₁-C₁₈ hydroxyl alkyl group, a C₁-C₁₈ alkenyl group, a C₁-C₁₈ alkynyl group, a C₁-C₁₈ acryl group, a C₁-C₁₈ cycloalkyl group, or a C₁-C₁₈ functional alkyl group.

In other embodiments, a method of using an emulsion may include extracting hydrocarbons in a downhole environment, transporting hydrocarbons in a pipeline, or cleaning a tank housing hydrocarbons. The emulsion may comprise an aqueous phase comprising an aqueous base fluid, a non-aqueous phase comprising hydrocarbons, and an emulsifier that is a pyridinium-based compound having the structure according to Chemical Structure #1 or a salt thereof. In Chemical Structure #1, X may be —CH₃, —OH, —NH₂, or —SH, and Y may be —CH₂—, —O—, —NR²—, or —S—, excluding where X is —CH₃ and Y is —CH₂—. Furthermore, R¹ may be a C₁-C₁₈ alkyl group, a C₁-C₁₈ hydroxyl alkyl group, a C₁-C₁₈ alkenyl group, a C₁-C₁₈ internal alkynyl group, a C₁-C₁₈ acryl group, a C₁-C₁₈ cycloalkyl group, or a C₁-C₁₈ functional alkyl group; and each of R², R_{A}, R_{B}, R_{C}, R_{D}, and R_{E} may be chosen from hydrogen, a C₁-C₁₈ alkyl group, a C₁-C₁₈ hydroxyl alkyl group, a C₁-C₁₈ alkenyl group, a C₁-C₁₈ alkynyl group, a C₁-C₁₈ acryl group, a C₁-C₁₈ cycloalkyl group, or a C₁-C₁₈ functional alkyl group.

These and other embodiments are described in more detail in the detailed description. It is to be understood that both the foregoing general description and the following detailed description present embodiments of the presently disclosed technology, and are intended to provide an overview or framework for understanding the nature and character of the presently disclosed technology as it is claimed. The accompanying drawings are included to provide a further understanding of the presently disclosed technology and are incorporated into and constitute a part of this specification. The drawings illustrate various embodiments and, together with the description, serve to explain the principles and operations of the presently disclosed technology. Additionally, the drawings and descriptions are meant to be merely illustrative, and are not intended to limit the scope of the claims in any manner.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 graphically depicts data related to the surface tension of water at a water-air interface as a function of the concentration of an example emulsifier disclosed herein;

FIG. 2 depicts an image related to the stability of emulsions containing various amounts of the example emulsifier of FIG. 1; and

FIG. 3 depicts an image related to the stability of emulsions containing various aqueous phase fractions.

### DETAILED DESCRIPTION

One or more embodiments of the present disclosure are directed to emulsions. As used herein, the term “emulsion” refers to a two-phase fluid, including an aqueous phase and a non-aqueous phase, in which the non-aqueous phase may be dispersed in the aqueous phase (e.g. an oil-in-water emulsion) or the aqueous-phase may be dispersed in the non-aqueous phase (e.g. a water-in-oil emulsion).

Emulsions may be used in a wide variety of industrial processes. For example, in the petroleum industry, emulsions appear in various stages of oil production and processing. Particularly, emulsions are often created to alter the viscosity and flow characteristics of fluids to enhance crude oil recovery, improve production efficiency, and reduce transmission costs. However, the harsh conditions (e.g. high temperature, high pressure, and/or high acidity) in a reservoir and the high salinity of the brines cause the majority of commercially-available emulsifiers to undergo decomposition or precipitation and therefore reduce their effectiveness.

It has been presently discovered that the emulsifiers disclosed herein may offer enhanced stability, especially in various conditions that may be experienced in oil production. Specifically, the presently disclosed emulsifiers, such as those of Chemical Structure #1 shown herein, may offer enhanced stability at high temperatures and/or high pressures as compared to conventional emulsifiers.

In one or more embodiments, the emulsions described herein may comprise an aqueous phase, a non-aqueous phase, and an emulsifier. As used in the present disclosure, the term “aqueous” refers to fluids or solutions including water as the major constituent. The term “non-aqueous” refers to fluids or solutions including a major constituent that is immiscible with water. In some embodiments, the aqueous phase is a continuous phase and the non-aqueous phase is dispersed in the continuous phase. In other embodiments disclosed herein, the non-aqueous phase is a continuous phase and the aqueous phase is dispersed in the continuous phase.

In one or more embodiments, the aqueous phase may comprise an aqueous base fluid. The aqueous base fluid may include one or more of fresh water, salt water, brine, municipal water, formation water, produced water, well water, filtered water, distilled water, and seawater, or combinations of these.

According to one or more embodiments, the non-aqueous phase may comprise hydrocarbons. The hydrocarbons may be present in a non-aqueous base fluid such as an oil or a non-aqueous solution, such as an oil and one or more organic or inorganic compounds dissolved in the oil or otherwise completely miscible with the oil. The non-aqueous base fluid may include one or more crude oils or crude oil derivatives, such as one or more of gasoline, diesel, kerosene, bunker fuel, jet fuel, naphtha, and mineral oil. In embodiments, the non-aqueous base fluid may include a synthetic oil. As used in the present disclosure, the term “synthetic oil” refers to crude oil derivatives that have been chemically treated, altered, or refined to enhance certain chemical or physical properties. While crude oil derivatives may typically encompass several classes (for example, alkane, aromatic, sulfur-bearing, or nitrogen-bearing) of thousands of individual hydrocarbon compounds, a synthetic oil may include one class of only tens of individual hydrocarbon compounds (for example, ester compounds in a C₈₋₁₄ range). Suitable synthetic oils may include linear alpha olefins, isomerized olefins, poly alpha olefins, linear alkyl benzenes, vegetable and hydrocarbon-derived ester compounds, or combinations of these.

Reference will now be made in detail to the emulsifiers comprised within the emulsions disclosed herein. According to one or more embodiments, the emulsions disclosed herein may include an emulsifier, and the emulsifier may be a pyridinium-based compound. The pyridinium-based compounds described herein may generally be described by Chemical Structure #1. According to some embodiments, the pyridinium-based compounds may be cations as shown in Chemical Structure #1, where the N is shown as having a positive charge. In additional embodiments, the pyridinium-based compounds may be salts, where an anion (not shown) is bonded with the compound of Chemical Structure #1. For example, anions may include F, Cl, Br, or I, but are not particularly limited herein. In Chemical Structure #1, X may be —CH₃, —OH, —NH₂, or —SH, and Y may be —CH₂—, —O—, —NR²—, or —S—, excluding where X is —CH₃ and Y is —CH₂—. It should be understood that the symbol “-” is intended to show bonds within the compound to the X and Y atoms/groups, and that the “-” symbol is not intended to represent an additional carbon atom.

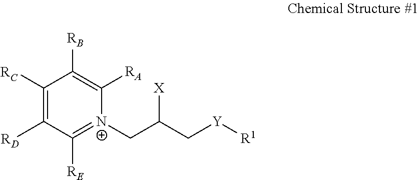

As shown, the presently disclosed emulsifiers may be cation emulsifiers. Emulsifiers generally can be categorized as cation emulsifiers, anion emulsifiers, non-ionic emulsifiers, and amphoteric emulsifiers. Without being bound by any particular theory, amphoteric emulsifiers can function as either anionic or cationic emulsifiers depending on the acidity of the solution; however, their dual nature can complicate formulations, requiring careful acidity control to maintain stability. Non-ionic emulsifiers are effective at emulsifying oils; however, their effectiveness can be greatly reduced in cold temperature. Anionic emulsifiers are effective in emulsifying aqueous solutions; however, their effectiveness can be reduced in hard water due to the formation of insoluble salts. In contrast, cationic emulsifiers have a positive charge, allowing them to from strong ionic bonds with negative ions in salt water, resist hydrolysis, and thereby stabilize emulsions in different environments. However, conventional emulsifiers currently used in the petroleum industry, such as cetyltrimethylammonium bromide (CTAB), degrade at temperatures above 150° C., rendering them ineffective in downhole environments.

As described herein, in Chemical Structure #1, X may be —OH as is depicted in Chemical Structure #2.

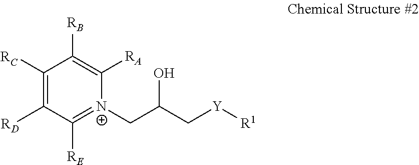

A pyridinium-based compound having the general structure described by Chemical Structure #2 may be formed by reacting pyridine, optionally substituted with one or more substituents, and a substituted epoxide, according to Reaction Scheme #1:

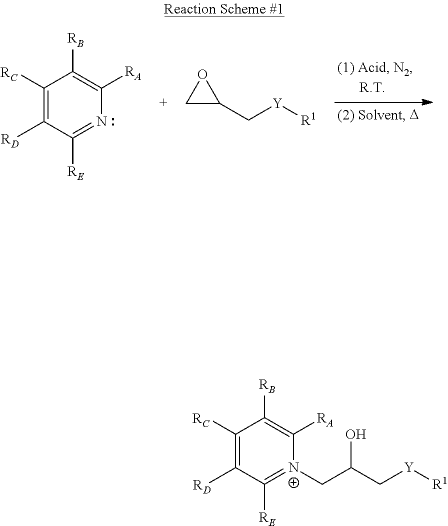

In Reaction Scheme #1, pyridine and acid (e.g. hydrochloric acid or hydrobromic acid) are mixed and purged with nitrogen at room temperature, followed by adding solvent (e.g. monoethylene glycol (MEG), diethylene glycol monoethyl ether (DGME), or 2-butoxyethanol) and then substituted epoxide (e.g. 1-dimethylamino-2,3-epoxypropane, 1-methylthio-2,3-epoxypropane, or other 1-alkylthio-2,3-epoxyproane). The reaction is carried out at an elevated temperature such as from 65° C. to 110° C.

In some embodiments, X may be —OH and Y may be —CH₂—, O—, —NR²—, or —S— as is depicted in Chemical Structures #2A, 2B, 2C, and 2D, respectively.

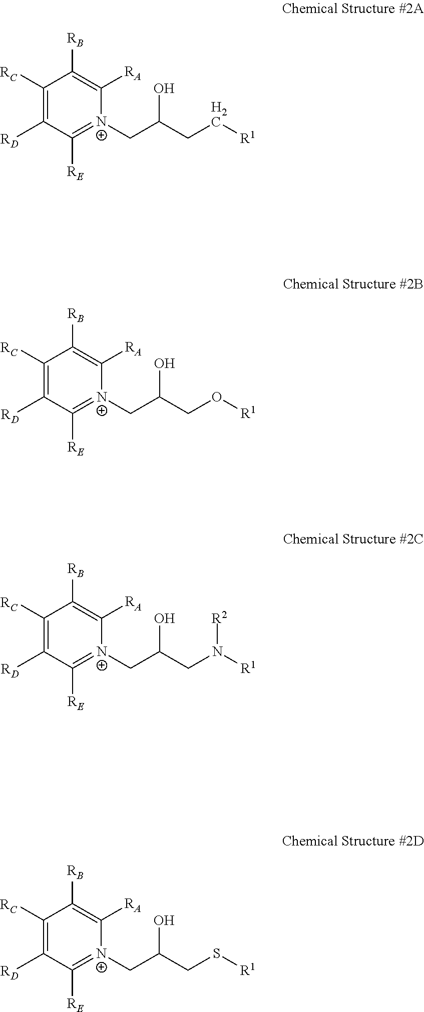

In other embodiments, X is —OH, and Y is —O—, as described by Chemical Structure #2B. In specific embodiments, X is —OH, Y is —O—, R¹ is a C₈ alkyl group, a C₁₀ alkyl group, or a C₁₂ alkyl group, and the pyridinium-based compound may be, for example, a 1-[3-(octyloxy)-2-hydroxypropyl]pyridinium compound, a 1-[3-(decyloxy)-2-hydroxypropyl]pyridinium compound, or a 1-[3-(dodecyloxy)-2-hydroxypropyl]pyridinium compound.

As described herein, in Chemical Structure #1, X may be —NH₂ as is depicted in Chemical Structure #3.

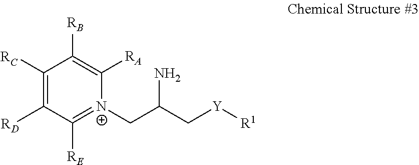

A pyridinium-based compound having the general structure of Chemical Structure #3 may be formed by reacting pyridine, optionally substituted with one or more substituents, and a substituted aziridine, according to Reaction Scheme #2:

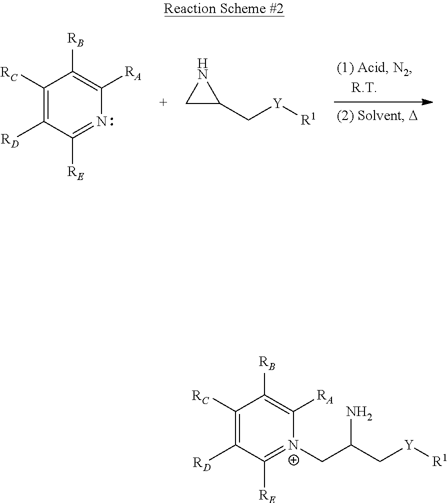

In Reaction Scheme #1, pyridine and acid (e.g. hydrochloric acid or hydrobromic acid) are mixed and purged with nitrogen at room temperature, followed by adding solvent (e.g. monoethylene glycol (MEG), diethylene glycol monoethyl ether (DGME), or 2-butoxyethanol) and then substituted aziridine (e.g. aziridine-2-yl methanol). The reaction is carried out at an elevated temperature such as from 65° C. to 110° C.

In some embodiments, X may be —NH₂ and Y may be —CH₂—, —O—, —NR²—, or —S— as is depicted in Chemical Structures #3A, 3B, 3C, and 3D, respectively.

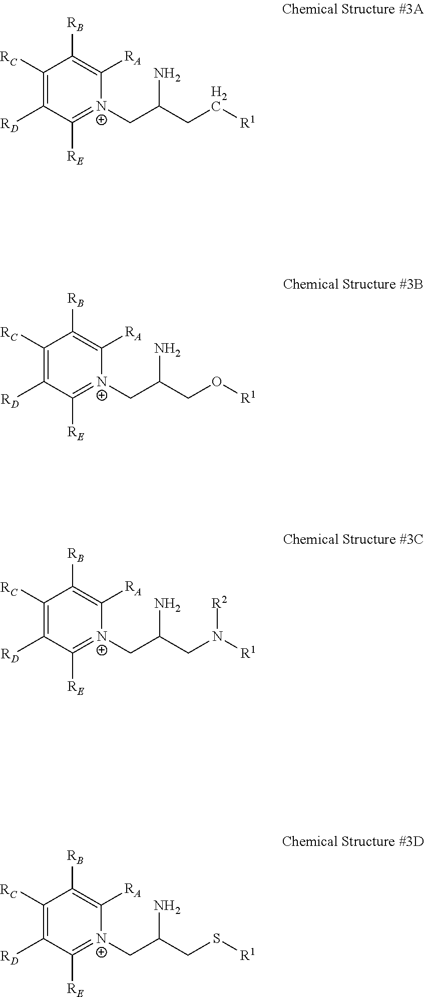

As described herein, in Chemical Structure #1, X may be —SH as is depicted in Chemical Structure #4.

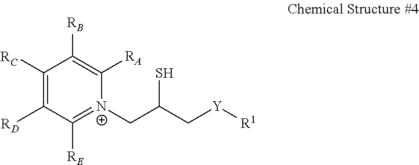

A pyridinium-based compound having the general structure of Chemical Structure #4 may be formed by reacting pyridine, optionally substituted with one or more substituents, and a substituted thiiranes, according to Reaction Scheme #3:

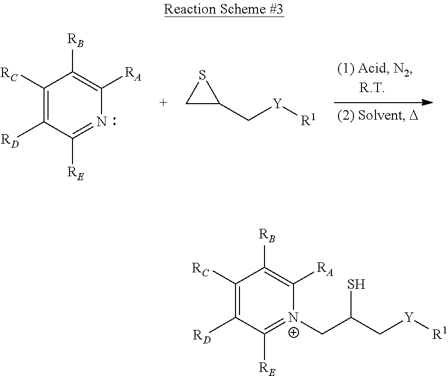

In Reaction Scheme #3, pyridine and acid (e.g. hydrochloric acid or hydrobromic acid) are mixed and purged with nitrogen at room temperature, followed by adding solvent (e.g. monoethylene glycol (MEG), diethylene glycol monoethyl ether (DGME), or 2-butoxyethanol) and then substituted thiirane (e.g. 2-(methoxymethyl) thiirane). The reaction is carried out at an elevated temperature such as from 65° C. to 110° C.

In some embodiments, X may be —SH and Y may be —CH₂—, —O—, —NR²—, or —S— as is depicted in Chemical Structures #4A, 4B, 4C, and 4D, respectively.

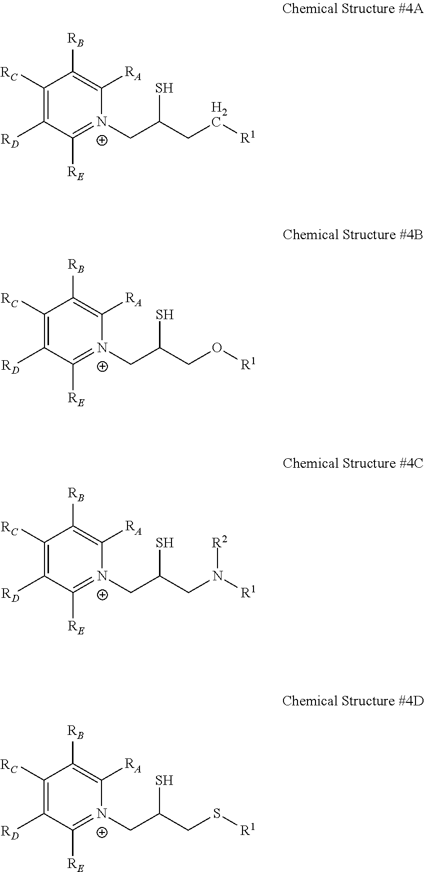

As described herein, in Chemical Structure #1, X may be —CH₃ as is depicted in Chemical Structure #5. Chemical Structure #5 can be prepared by using organic chemistry techniques recognized by those skilled in the art.

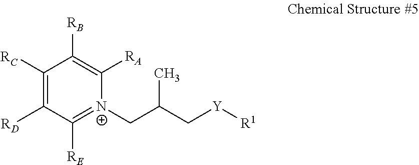

In some embodiments, X may be —CH₃ and Y may be —CH₂—, —O—, —NR²—, or —S— as is depicted in Chemical Structure #5A, 5B, 5C, and 5D, respectively.

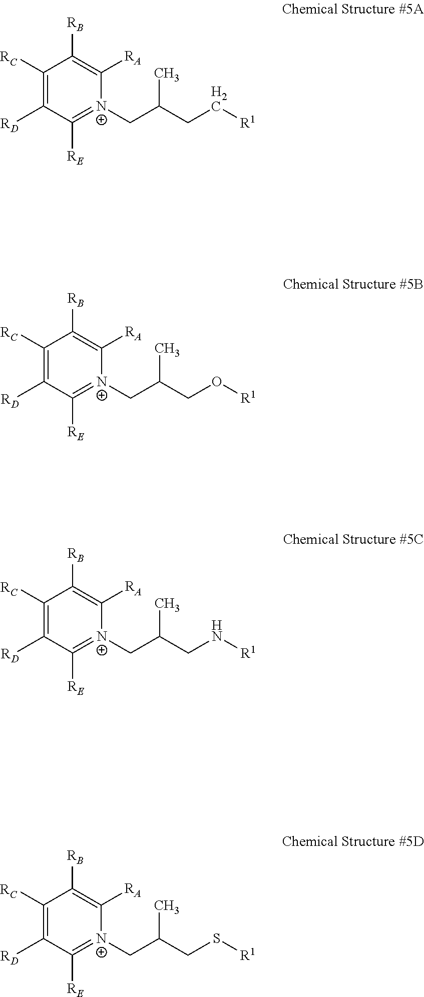

Without being bound by any particular theory, it is believe that the presence of non-carbon atoms in the functional group on the nitrogen atom of the pyridinium improves the thermal and chemical stability of the pyridinium-based compound, making them more effective under extreme conditions. Thus, in embodiments, pyridinium-based compounds disclosed herein exclude Chemical Structure #5A, where X is —CH₃ and Y is —CH₂—.

Referring back to Chemical Structure #1, as well as other chemical structures describe herein, the general structure includes R¹, R_{A}, R_{B}, R_{C}, R_{D}, and R_{E} that each represent various functional groups. Unless specified otherwise, discussion herein of R groups may refer to both the pyridinium-based compounds represented by Chemical Structure #1. R¹ may be a C₁-C₁₈ alkyl group, a C₁-C₁₈ hydroxyl alkyl group, a C₁-C₁₈ alkenyl group, a C₁-C₁₈ internal alkynyl group, a C₁-C₁₈ acryl group, a C₁-C₁₈ cycloalkyl group, or a C₁-C₁₈ functional alkyl group. R_{A}, R_{B}, R_{C}, R_{D}, and R_{E} may each independently chosen from hydrogen, a C₁-C₁₈ alkyl group, a C₁-C₁₈ hydroxyl alkyl group, a C₁-C₁₈ alkenyl group, a C₁-C₁₈ alkynyl group, a C₁-C₁₈ acryl group, a C₁-C₁₈ cycloalkyl group, or a C₁-C₁₈ functional alkyl group. Without being bound by a theory, it is believed that R¹ having a relatively long carbon chain moiety allows the pyridinium-based compound to form more stable emulsions at a reduced concentration of the pyridinium-based compound. In some embodiments, R¹ may be a C₆-C₁₈ alkyl group, a C₈-C₁₈ alkyl group, a C₆-C₁₂ alkyl group, a C₈-C₁₂ alkyl group, a C₈ alkyl group, or a C₁₀ alkyl group. In one embodiment, R¹ may be a C₈ alkyl group (i.e., an octyl group). In one embodiment, R¹ may be a C₁₀ alkyl group (i.e., a decyl group). In one embodiment, R¹ may be a C₁₂ alkyl group (i.e., a dodecyl group).

In one or more embodiments, the term “functional group” or “group” may refer to a substituent or moiety that is present in the pyridinium-based compound. For example, when the disclosure states that R¹ may be a methyl group, the methyl group (—CH₃) replaces R¹ of Chemical Structure #1, where the carbon atom of the methyl group is now bonded to the Y atom of Chemical Structure #1 to which R¹ bonded.

As described herein, moieties may be defined by the number of carbon atoms included in the moiety, such as Cₓ-C_{y}, where x is the least number of carbon atoms and y is the greatest number of carbon atoms contemplated. For example, C₁-C₁₈ describes a moiety that has from 1 to 18 carbon atoms.

In some embodiments, R¹, R_{A}, R_{B}, R_{C}, R_{D}, and R_{E} may each independently be a C₁-C₁₈ alkyl group. The term “alkyl group” refers to a functional group that only contains carbon and hydrogen atoms where the carbon atoms and hydrogen atoms are only connected by single bonds. In some embodiments, R¹, R_{A}, R_{B}, R_{C}, R_{D}, and R_{E} may each independently be a straight chained alkyl group having the chemical formula —(CH₂)ₓCH₃, where x is from 0 to 17, such as 0 (a methyl group), 1, 2, 3, 4, 5, 6, 7, 8, 9, 10, 11, 12, 13, 14, 15, 16, 17, or 18 carbon atoms. In additional embodiments, R¹, R_{A}, R_{B}, R_{C}, R_{D}, and R_{E} may each independently be branched alkyl groups having from 3 to 18 carbon atoms, such as 3, 4, 5, 6, 7, 8, 9, 10, 11, 12, 13, 14, 15, 16, 17, or 18 carbon atoms. In some embodiments, the alkyl group may include a ring structure, such as a pentane ring, a hexane ring, etc.

In some embodiments, R¹, R_{A}, R_{B}, R_{C}, R_{D}, and R_{E} may each independently comprise a C₁-C₁₈ hydroxyl alkyl group. The term “hydroxyl alkyl group” refers to a functional group that includes one or more a hydroxyl moieties (—OH) bonded to an alkyl group. According to embodiments, the hydroxyl alkyl group may include 1, 2, 3, 4, 5, or even more hydroxyl moieties. In some embodiments, R¹, R_{A}, R_{B}, R_{C}, R_{D}, and R_{E} may each independently be a straight chained hydroxyl alkyl group having the chemical formula —(CH₂)ₓOH, where x is from 1 to 18. In additional embodiments, R¹, R_{A}, R_{B}, R_{C}, R_{D}, and R_{E} may each independently be branched hydroxyl alkyl groups having from 1 to 18 carbon atoms and at least one hydroxyl group.

In some embodiments, R¹, R_{A}, R_{B}, R_{C}, R_{D}, and R_{E} may each independently comprise a C₁-C₁₈ alkenyl group. The term “alkenyl group” refers to a functional group consisting of hydrogen and carbon atoms where at least two carbon atoms have a double bond. In some embodiments, the alkenyl group may have a single carbon to carbon double bond that is at the end of moiety (i.e., having the structure —(CH₂)ₓCH═CH₂, where x is from 0 to 16, such as 0, 1, 2, 3, 4, 5, 6, 7, 8, 9, 10, 11, 12, 13, 14, 15, or 16).

In some embodiments, R¹, R_{A}, R_{B}, R_{C}, R_{D}, and R_{E} may each independently comprise a C₁-C₁₈ alkynyl group. The term “alkynyl group” refers to a functional group consisting of hydrogen and carbon atoms where at least two carbon atoms have a triple bond. In some embodiments, R_{A}, R_{B}, R_{C}, R_{D}, and R_{E} may each independently have a single carbon to carbon triple bond that is at the end of moiety (i.e., having the structure —(CH₂)ₓC≡CH, where x is from 0 to 16, such as 0, 1, 2, 3, 4, 5, 6, 7, 8, 9, 10, 11, 12, 13, 14, 15, or 16).

In some embodiments, R¹, R_{A}, R_{B}, R_{C}, R_{D}, and R_{E} may each independently be a C₁-C₁₈ acryl group. The term “acryl group” refers to a functional group consisting of a carbon-carbon double bond and a carbon-oxygen double bond separated by a carbon-carbon single bond. The acryl group may have the general formula —(CH₂)ₙCOCHCH₂, where n is any integer from 0 to 15, such as 0, 1, 2, 3, 4, 5, 6, 7, 8, 9, 10, 11, 12, 13, 14, or 15.

In some embodiments, R¹, R_{A}, R_{B}, R_{C}, R_{D}, and R_{E} may each independently be a C₁-C₁₈ functional alkyl group. The term “functional alkyl group” refers to an alkyl group that includes at least one moiety bonded to any carbon atom of the alkyl group. In some embodiments, the functional alkyl group may comprise more than one of the same moiety. In some embodiments, the functional alkyl group may comprise two or more different moieties. In some embodiments, the functional alkyl group may comprise a moiety chosen form a carboxyl group (i.e., —COOH), an amine group (i.e., —NH₂), or a thiol group (i.e., —SH).

In some embodiments, R¹ may be a C₂-C₁₇ alkyl group, and R_{A}, R_{B}, R_{C}, R_{D}, and R_{E} may each be hydrogen. For example, R¹ may be a C₄-C₁₆ alkyl group, a C₆-C₁₄ alkyl group, or a C₈-C₁₂ alkyl group. In some embodiments, R¹ may be a C₁-C₁₇, a C₁-C₁₆, a C₁-C₁₅, a C₁-C₁₄, a C₁-C₁₃, a C₁-C₁₂, a C₁-C₁₁, a C₁-C₁₀, a C₁-C₉, a C₁-C₈, a C₁-C₇, a C₁-C₆, a C₁-C₅, a C₁-C₄, a C₁-C₃, or a C₁-C₂ alkyl group. In some embodiments, R¹ may be a C₂-C₁₈, C₃-C₁₈, C₄-C₁₈, C₅-C₁₈, C₆-C₁₈, C₇-C₁₈, C₈-C₁₈, C₉-C₁₈, C₁₀-C₁₈, C₁₁-C₁₈, C₁₂-C₁₈, C₁₃-C₁₈, C₁₄-C₁₈, C₁₅-C₁₈, C₁₆-C₁₈, or C₁₇-C₁₈ alkyl group. In one embodiment, R¹ may be a C₈-C₁₂ alkyl group, and R_{A}, R_{B}, R_{C}, R_{D}, and R_{E} may each be hydrogen. In one embodiment, R¹ may be a C₈ alkyl group (i.e., an octyl group) and R_{A}, R_{B}, R_{C}, R_{D}, and R_{E} may each be hydrogen. In one embodiment, R¹ may be a C₁₀ alkyl group (i.e., a decyl group) and R_{A}, R_{B}, R_{C}, R_{D}, and R_{E} may each be hydrogen. In one embodiment, R¹ may be a C₁₂ alkyl group (i.e., a dodecyl group) and R_{A}, R_{B}, R_{C}, R_{D}, and R_{E} may each be hydrogen.

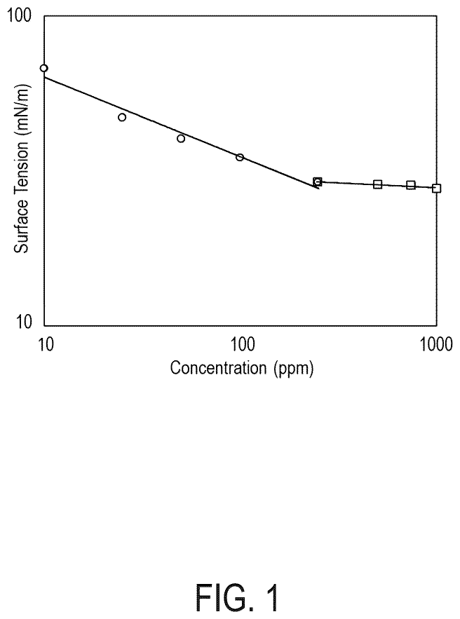

Referring to FIG. 1, the effectiveness of an emulsifier may be evaluated by the Critical Micelle Concentration (CMC) of the emulsifier. As used herein, the term “Critical Micelle Concentration” or “CMC” refers to the concentration of an emulsifier at which micelles start to form. As used herein, the term “micelle” refers to an aggregation or assembly of emulsifier molecules or compounds, forming a colloidal particle that encapsulates either an aqueous phase fluid or a non-aqueous phase fluid. According to embodiments, the emulsifier disclosed herein may have a CMC that is greater than or equal to 100 parts per million (ppm) and less than or equal to 500 ppm of the total weight of the emulsion, such as greater than or equal to 100 ppm and less than or equal to 400 ppm, greater than or equal to 100 ppm and less than or equal to 300 ppm, greater than or equal to 100 ppm and less than or equal to 200 ppm, greater than or equal to 200 ppm and less than or equal to 500 ppm, greater than or equal to 200 ppm and less than or equal to 400 ppm, greater than or equal to 200 ppm and less than or equal to 300 ppm, greater than or equal to 300 ppm and less than or equal to 500 ppm, greater than or equal to 300 ppm and less than or equal to 400 ppm, or greater than or equal to 400 ppm and less than or equal to 500 ppm, as measured at a water-air interface.

Furthermore, the effectiveness of an emulsifier may also be evaluated by the interfacial tension between an aqueous phase fluid (e.g. water) and a non-aqueous phase fluid (e.g. dodecane). As used herein the term “interfacial tension” refers to the surface free energy of the interface between two immiscible liquids; for example, a water-dodecane interface. According to embodiments, the emulsifier has an interfacial tension that is less than 5.0 mN/m, such as less than 4.0 mN/m, less than 3.0 mN/m, less than 2.0 mN/m, less than 1.0 mN/m, from 1.0 mN/m to 5.0 mN/m, from 1.0 mN/m to 4.0 mN/m, from 1.0 mN/m to 3.0 mN/m, from 1.0 mN/m to 2.0 mN/m, from 2.0 mN/m to 5.0 mN/m, from 2.0 mN/m to 4.0 mN/m, from 2.0 mN/m to 3.0 mN/m, from 3.0 mN/m to 5.0 mN/m, from 3.0 mN/m to 4.0 mN/m, or from 4.0 mN/m to 5.0 mN/m, measured at a water-dodecane interface at a temperature of 25° C. using Wilhelmy plate method. In specific embodiments, the emulsifier has an interfacial tension that is 4.87 mN/m, measured at a water-dodecane interface at a temperature of 25° C. using Wilhelmy plate method.

Without being bound by any particular theory, it is believed that the stability of an emulsion depends on various factors, such as the amount of emulsifiers, the relative fractions of aqueous and non-aqueous phases, the temperature and pressure of the environment, and the acidity and salinity of the aqueous based fluids.

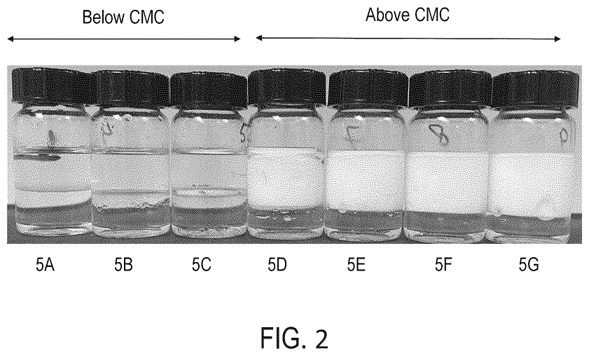

Referring to FIG. 2, and according to embodiments, emulsions disclosed herein remain relatively stable across a wide range of pyridinium-based compound concentrations. According to embodiments disclosed herein, the emulsion may comprise an emulsifier, where the emulsifier is in an amount that is greater than or equal to 50 ppm and less than or equal to 1,500 ppm of the total weight of the emulsion, such as greater than or equal to 50 ppm and less than or equal to 1,200 ppm, greater than or equal to 50 ppm and less than or equal to 1,000 ppm, greater than or equal to 50 ppm and less than or equal to 800 ppm, greater than or equal to 50 ppm and less than or equal to 500 ppm, greater than or equal to 50 ppm and less than or equal to 300 ppm, greater than or equal to 300 ppm and less than or equal to 1,500 ppm, greater than or equal to 300 ppm and less than or equal to 1,200 ppm, greater than or equal to 300 ppm and less than or equal to 1,000 ppm, greater than or equal to 300 ppm and less than or equal to 800 ppm, greater than or equal to 300 ppm and less than or equal to 500 ppm, greater than or equal to 500 ppm and less than or equal to 1,500 ppm, greater than or equal to 500 ppm and less than or equal to 1,200 ppm, greater than or equal to 500 ppm and less than or equal to 1,000 ppm, greater than or equal to 500 ppm and less than or equal to 800 ppm, greater than or equal to 800 ppm and less than or equal to 1,500 ppm, greater than or equal to 800 ppm and less than or equal to 1,200 ppm, greater than or equal to 800 ppm and less than or equal to 1,000 ppm, greater than or equal to 1,000 ppm and less than or equal to 1,500 ppm, greater than or equal to 1,000 ppm and less than or equal to 1,200 ppm, or greater than or equal to 1,200 ppm and less than or equal to 1,500 ppm.

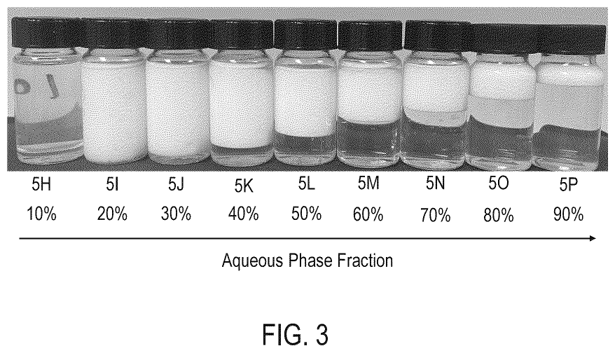

Referring to FIG. 3, and according to embodiments, emulsions comprising a pyridinium-based compound disclosed herein at a concentration above the CMC of the pyridinium-based compound remain stable across a wide range of aqueous phase fractions.

According to embodiments disclosed herein, the aqueous phase may comprise greater than or equal to greater than or equal to 10 vol. % and less than or equal to 90 vol. % of the total volume of the emulsion, such as greater than or equal to 10 vol. % and less than or equal to 80 vol. %, greater than or equal to 10 vol. % and less than or equal to 60 vol. %, greater than or equal to 10 vol. % and less than or equal to 40 vol. %, greater than or equal to 10 vol. % and less than or equal to 30 vol. %, greater than or equal to 10 vol. % and less than or equal to 20 vol. %, greater than or equal to 10 vol. % and less than or equal to 15 vol. %, greater than or equal to 15 vol. % and less than or equal to 90 vol. %, greater than or equal to 15 vol. % and less than or equal to 80 vol. %, greater than or equal to 15 vol. % and less than or equal to 60 vol. %, greater than or equal to 15 vol. % and less than or equal to 40 vol. %, greater than or equal to 15 vol. % and less than or equal to 30 vol. %, greater than or equal to 15 vol. % and less than or equal to 20 vol. %, greater than or equal to 20 vol. % and less than or equal to 90 vol. %, greater than or equal to 20 vol. % and less than or equal to 80 vol. %, greater than or equal to 20 vol. % and less than or equal to 60 vol. %, greater than or equal to 20 vol. % and less than or equal to 40 vol. %, greater than or equal to 20 vol. % and less than or equal to 30 vol. %, greater than or equal to 30 vol. % and less than or equal to 90 vol. %, greater than or equal to 30 vol. % and less than or equal to 80 vol. %, greater than or equal to 30 vol. % and less than or equal to 60 vol. %, greater than or equal to 30 vol. % and less than or equal to 40 vol. %, greater than or equal to 40 vol. % and less than or equal to 90 vol. %, greater than or equal to 40 vol. % and less than or equal to 80 vol. %, greater than or equal to 40 vol. % and less than or equal to 60 vol. %, greater than or equal to 60 vol. % and less than or equal to 90 vol. %, greater than or equal to 60 vol. % and less than or equal to 80 vol. %, or greater than or equal to 80 vol. % and less than or equal to 90 vol. % of the total volume of the emulsion. In specific embodiments, the aqueous phase may comprise greater than or equal to 15 vol. % and less than or equal to 40 vol. % of the total volume of the emulsion or greater than or equal to 20 vol. % and less than or equal to 30 vol. % of the total volume of the emulsion.

According to embodiments disclosed herein, the non-aqueous phase may comprise greater than or equal to 10 vol. % and less than or equal to 90 vol. % of the total volume of the emulsion, such as greater than or equal to 10 vol. % and less than or equal to 85 vol. %, greater than or equal to 10 vol. % and less than or equal to 80 vol. %, greater than or equal to 10 vol. % and less than or equal to 70 vol. %, greater than or equal to 10 vol. % and less than or equal to 60 vol. %, greater than or equal to 10 vol. % and less than or equal to 40 vol. %, greater than or equal to 10 vol. % and less than or equal to 25 vol. %, greater than or equal to 25 vol. % and less than or equal to 90 vol. %, greater than or equal to 25 vol. % and less than or equal to 85 vol. %, greater than or equal to 25 vol. % and less than or equal to 80 vol. %, greater than or equal to 25 vol. % and less than or equal to 70 vol. %, greater than or equal to 25 vol. % and less than or equal to 60 vol. %, greater than or equal to 25 vol. % and less than or equal to 40 vol. %, greater than or equal to 40 vol. % and less than or equal to 90 vol. %, greater than or equal to 40 vol. % and less than or equal to 85 vol. %, greater than or equal to 40 vol. % and less than or equal to 80 vol. %, greater than or equal to 40 vol. % and less than or equal to 70 vol. %, greater than or equal to 40 vol. % and less than or equal to 60 vol. %, greater than or equal to 60 vol. % and less than or equal to 90 vol. %, greater than or equal to 60 vol. % and less than or equal to 85 vol. %, greater than or equal to 60 vol. % and less than or equal to 80 vol. %, greater than or equal to 60 vol. % and less than or equal to 70 vol. %, greater than or equal to 70 vol. % and less than or equal to 90 vol. %, greater than or equal to 70 vol. % and less than or equal to 85 vol. %, greater than or equal to 70 vol. % and less than or equal to 80 vol. %, greater than or equal to 80 vol. % and less than or equal to 90 vol. %, greater than or equal to 80 vol. % and less than or equal to 85 vol. %, or greater than or equal to 85 vol. % and less than or equal to 90 vol. % of the total volume of the emulsion. In specific embodiments, the non-aqueous phase may comprise greater than or equal to 60 vol. % and less than or equal to 85 vol. % of the total volume of the emulsion or greater than or equal to 70 vol. % and less than or equal to 80 vol. % of the total volume of the emulsion.

In some embodiments, the aqueous phase may comprise greater than or equal to 15 vol. % and less than or equal to 40 vol. % of the total volume of the emulsion; and the non-aqueous phase may comprise greater than or equal to 60 vol. % and less than or equal to 85 vol. % of the total volume of the emulsion. In other embodiments, the aqueous phase may comprise greater than or equal to 20 vol. % and less than or equal to 30 vol. % of the total volume of the emulsion; and the non-aqueous phase may comprise greater than or equal to 70 vol. % and less than or equal to 80 vol. % of the total volume of the emulsion.

The temperature of hydrocarbon fluids in an oil reservoir, pipeline, and tank can range from 25° C. to 150° C. In some embodiments, the emulsion may have a temperature that is greater than or equal to 25° C. and less than or equal to 150° C., such as greater than or equal to 25° C. and less than or equal to 120° C., greater than or equal to 25° C. and less than or equal to 100° C., greater than or equal to 25° C. and less than or equal to 80° C., greater than or equal to 25° C. and less than or equal to 60° C., greater than or equal to 25° C. and less than or equal to 40° C., greater than or equal to 40° C. and less than or equal to 150° C., greater than or equal to 40° C. and less than or equal to 120° C., greater than or equal to 40° C. and less than or equal to 100° C., greater than or equal to 40° C. and less than or equal to 80° C., greater than or equal to 40° C. and less than or equal to 60° C., greater than or equal to 60° C. and less than or equal to 150° C., greater than or equal to 60° C. and less than or equal to 120° C., greater than or equal to 60° C. and less than or equal to 100° C., greater than or equal to 60° C. and less than or equal to 80° C., greater than or equal to 80° C. and less than or equal to 150° C., greater than or equal to 80° C. and less than or equal to 120° C., greater than or equal to 80° C. and less than or equal to 100° C., greater than or equal to 100° C. and less than or equal to 150° C., greater than or equal to 100° C. and less than or equal to 120° C., greater than or equal to 120° C. and less than or equal to 150° C.

The pressure of hydrocarbon fluids in an oil reservoir, pipeline, and tank can range from 15 psi to 30,000 psi. In some embodiments, the emulsion may have a pressure of greater than or equal to 15 psi and less than or equal to 10,000 psi, such as greater than or equal to 15 psi and less than or equal to 8,000 psi, greater than or equal to 15 psi and less than or equal to 6,000 psi, greater than or equal to 15 psi and less than or equal to 4,000 psi, greater than or equal to 15 psi and less than or equal to 2,000 psi, greater than or equal to 15 psi and less than or equal to 1,000 psi, greater than or equal to 15 psi and less than or equal to 500 psi, greater than or equal to 15 psi and less than or equal to 200 psi, greater than or equal to 15 psi and less than or equal to 100 psi, greater than or equal to 100 psi and less than or equal to 10,000 psi, greater than or equal to 100 psi and less than or equal to 8,000 psi, greater than or equal to 100 psi and less than or equal to 6,000 psi, greater than or equal to 100 psi and less than or equal to 4,000 psi, greater than or equal to 100 psi and less than or equal to 2,000 psi, greater than or equal to 100 psi and less than or equal to 1,000 psi, greater than or equal to 100 psi and less than or equal to 500 psi, greater than or equal to 100 psi and less than or equal to 200 psi, greater than or equal to 200 psi and less than or equal to 10,000 psi, greater than or equal to 200 psi and less than or equal to 8,000 psi, greater than or equal to 200 psi and less than or equal to 6,000 psi, greater than or equal to 200 psi and less than or equal to 4,000 psi, greater than or equal to 200 psi and less than or equal to 2,000 psi, greater than or equal to 200 psi and less than or equal to 1,000 psi, greater than or equal to 200 psi and less than or equal to 500 psi, greater than or equal to 500 psi and less than or equal to 10,000 psi, greater than or equal to 500 psi and less than or equal to 8,000 psi, greater than or equal to 500 psi and less than or equal to 6,000 psi, greater than or equal to 500 psi and less than or equal to 4,000 psi, greater than or equal to 500 psi and less than or equal to 2,000 psi, greater than or equal to 500 psi and less than or equal to 1,000 psi, greater than or equal to 1,000 psi and less than or equal to 10,000 psi, greater than or equal to 1,000 psi and less than or equal to 8,000 psi, greater than or equal to 1,000 psi and less than or equal to 6,000 psi, greater than or equal to 1,000 psi and less than or equal to 4,000 psi, greater than or equal to 1,000 psi and less than or equal to 2,000 psi, greater than or equal to 2,000 psi and less than or equal to 10,000 psi, greater than or equal to 2,000 psi and less than or equal to 8,000 psi, greater than or equal to 2,000 psi and less than or equal to 6,000 psi, greater than or equal to 2,000 psi and less than or equal to 4,000 psi, greater than or equal to 4,000 psi and less than or equal to 10,000 psi, greater than or equal to 4,000 psi and less than or equal to 8,000 psi, greater than or equal to 4,000 psi and less than or equal to 6,000 psi, greater than or equal to 6,000 psi and less than or equal to 10,000 psi, greater than or equal to 6,000 psi and less than or equal to 8,000 psi, or greater than or equal to 8,000 psi and less than or equal to 10,000 psi.

The acidity of well fluids in an oil reservoir can vary. For example, during acidizing, the acidizing fluid may have a pH value of less than or equal to 4, or even less than or equal to 2. According to embodiments disclosed herein, the emulsion may comprise an aqueous base fluid, wherein the aqueous base fluid may have a pH value that is less than or equal to 9, such as less than or equal to 6, less than or equal to 5.5, less than or equal to 5, less than or equal to 4.5, less than or equal to 4, less than or equal to 3.5, less than or equal to 3, less than or equal to 2.5, less than or equal to 2, greater than and equal to 2 and less than or equal to 9, greater than and equal to 2 and less than or equal to 6, greater than and equal to 2 and less than or equal to 5, greater than and equal to 2 and less than or equal to 4, greater than and equal to 2 and less than or equal to 3, greater than and equal to 3 and less than or equal to 9, greater than and equal to 3 and less than or equal to 6, greater than and equal to 3 and less than or equal to 5, greater than and equal to 3 and less than or equal to 4, greater than and equal to 4 and less than or equal to 9, greater than and equal to 4 and less than or equal to 6, greater than and equal to 4 and less than or equal to 5, greater than and equal to 5 and less than or equal to 9, greater than and equal to 5 and less than or equal to 6, or greater than and equal to 6 and less than or equal to 9.

Brine is a highly saline water and is a byproduct of the extraction of crude oil and natural gas. According to embodiments disclosed herein, the emulsion may comprise an aqueous base fluid, wherein the aqueous base fluid may have a salinity that is less than or equal to 350 gram per liter (g/L), such as less than or equal to 250 g/L, less than or equal to 150 g/L, less than or equal to 50 g/L, from 25 g/L to 350 g/L, from 25 g/L to 250 g/L, from 25 g/L to 150 g/L, from 25 g/L to 50 g/L, from 50 g/L to 350 g/L, from 50 g/L to 250 g/L, from 50 g/L to 150 g/L, from 150 g/L to 350 g/L, from 150 g/L to 250 g/L, or from 250 g/L to 350 g/L.

As discussed herein above, the emulsions disclosed herein are versatile and suitable for a wide range of applications that require vastly different emulsifier concentrations under various conditions, including extreme ones such as a downhole environment where the hydrocarbons are being extracted. According to embodiments, the emulsions or the emulsifiers disclosed herein may be present in, for example, and without limitation, drilling fluids, uncracking fluids, cementing fluids, foam drainage fluids, fracturing fluids, and acidifying fluids. In some embodiments, the emulsions or the emulsifiers may be present in formulation of a variety of products, for example, and without limitation, oil repellents, anti-wax and wax cleaning agents, wetting and dragging agents, emulsifying and viscosity-reducing agents, biocides, crude oil demulsifiers, anti-condensation and viscosity-reducing agents, dragging agents, antioxidants, anti-friction agents, detergents, anti-rust agents, anti-static agents, and fuel energy-saving additives. Furthermore, in one embodiment, the emulsions or the emulsifiers disclosed herein may be present in a downhole environment where hydrocarbons are being extracted. In one embodiment, the emulsions or the emulsifiers disclosed herein may be present in a pipeline transporting hydrocarbons. In one embodiment, the emulsions or the emulsifiers disclosed herein may be present in a tank housing hydrocarbons during tank cleaning.

According to one or more embodiments, it is contemplated that the presently disclosed compounds may be fabricated using organic chemistry techniques known to those skilled in the art. Without limitation, in some embodiments, the corrosion resistant compounds may be fabricated by grafting a functional group (such as that including the X and Y atoms) onto a pyridinium compound. For example, if X is C, a substituted epoxide may be reacted with pyridinium to form the corrosion-resistant compounds.

The present disclosure is also directed methods for using the emulsions or emulsifiers disclosed herein. In some embodiments, methods for extracting hydrocarbons in a downhole environment may comprise utilizing the emulsions or emulsifiers disclosed herein. In some embodiments, methods for transporting hydrocarbons in a pipeline may include utilizing the emulsions or emulsifiers disclosed herein. In some embodiments, methods for cleaning a tank housing hydrocarbons may comprise utilizing the emulsions or emulsifiers disclosed herein.

### EXAMPLES

The following examples are provided for illustrative purposes and may disclose one or more embodiments of the present disclosure. The examples are presented in such a way that those skilled in the art will recognize the Examples are not intended to limit the present disclosure or the appended claims.

### Example 1—Synthesis of 1-[3-(Decyloxy)-2-Hydroxypropyl]Pyridinium Chloride

Pyridine (1.5 mol) and hydrochloric acid (1 mol) were added to a round bottom flask and purged with nitrogen and stirred at room temperature (25° C.) for 10 minutes. Then, octyl/decyl glycidyl ether (1 mol) was added to the flask and again stirred for 30 minutes and then the contents of the flask were heated at 110° C. for 6 hours. At the end of this elapsed time, excess pyridine was removed from the final solution using a rotavapor.

The final solution was added to a separating funnel and dichloromethane (CH₂Cl₂) and a saturated solution of NaCl in water and potassium carbonate (K₂CO₃) was added to separate the organic and aqueous phases. The organic phase was collected and a rotavapor was used to remove the organic solvent and dark brown gel-like 1-[3-(decyloxy)-2-hydroxypropyl]pyridinium chloride was collected.

The composition of the final product tested contained 54.87% pyridinium salt, 37.41% monoethylene glycol, and 7.7% 2-butoxyethanol.

The pyridine, octyl/decyl glycidyl ether, hydrochloric acid (37%), dichloromethane, and diethyl ether were purchased from Sigma-Aldrich and used without any further purification.

### Comparative Example 2—Cetyltrimethylammonium Bromide, CTAB

Comparative example 2 is a commercially available emulsifier cetyltrimethylammonium bromide (CTAB) (Sigma-Aldrich, 98%).

### Example 3—Critical Micelle Concentration

Critical micelle concentration of Example 1 was determined by measuring the surface tension of water as a function of the concentration of Example 1.

FIG. 1 depicts the reduction in the surface tension of water at a water-air interface as a function of the concentration of Example 1. As shown in FIG. 1, the addition of Example 1 reduced the surface tension of water at the water-air interface until an amount of about 100 ppm of the total weight of the emulsion. When the pyridinium-based compound was present in an amount greater than 100 ppm of the total weight of the emulsion, the surface tension of the water remained relatively constant, indicating that the embodiment emulsifier has a CMC that is greater than or equal to 100 parts per million (ppm).

Based on FIG. 1, the CMC of Example 1 was determined to be about 250 ppm, significantly lower than the CMC of Comparative Example 2, which was reported as 360 ppm.

### Example 4—Interfacial Tension at a Water-Dodecane Interface

Table 1 shows the result of interfacial tension (IFT) at an interface between pure water and dodecane (Sigma-Aldrich, 99%) measured at the critical micelle concentrations of Example 1 and Comparative Example 2. The interfacial tension is measured using the Wilhelmy plate method

The blank sample included water and dodecane, and the interfacial tension was measured as 47.0 millinewton/m (mN/m). In the presence of Example 1 at a concentration of about 250 ppm, the interfacial tension between water and dodecane was reduced to 4.87 mN/m. In contrast, in the presence of Comparative Example 2 at a concentration of 360 ppm, the interfacial tension between water and dodecane was reduced to 5.33 mN/m.

TABLE 1
Interfacial Tension of Example 1

| | CMC | Interfacial |
|---|---|---|
| Sample | (ppm) | Tension (mN/m) |
| Blank (Water + Dodecane) | — | 47.0 |
| Example 1 | 250 | 4.87 |
| Comparative Example 1 | 360 | 5.33 |

### Example 5—Emulsification Test

Emulsification tests were performed to demonstrate the stability of emulsions. FIG. 2 shows the emulsification tests of Examples 5A to 5G, which contained a constant aqueous and non-aqueous phase fractions and various amounts of Example 1 emulsifier. FIG. 3 shows the emulsification tests of Examples 5H to 5P, which contained various aqueous and non-aqueous phase fractions and a constant amount of Example 1 emulsifier.

Each of examples 5A to 5G was prepared by blending water and dodecane at a 1:1 volume ratio with Example 1, at a concentration ranging from 0 ppm to 1000 ppm. The blend was mixed at a high speed of 5000 rpm for 1 minute. For Examples 5A to 5C, the concentrations of Example 1 were 0 ppm, 25 ppm, and 100 ppm, respectively, less than the CMC of Example 1. For Examples 5D to 5G, the concentrations of Example 1 were 250 ppm, 500 ppm, 750 ppm, and 1000 ppm, respectively, higher than the CMC of Example 1. As shown in FIG. 2, after blending, the aqueous and non-aqueous phases of Examples 5A to 5C remained separated. In contrast, emulsions were formed in Examples 5D to 5G after blending and remained stable post 7 days of emulsification.

Each of Examples 5H to 5P was prepared by blending a mixture containing water and dodecane at varying volume ratios with Example 1, at a constant concentration of 1000 ppm. The blend was mixed at a high speed of 5000 rpm for 1 minute. The aqueous phase fractions of Examples 5H to 5P were varied from 10% (Example 5H) to 90% (Example 5P) at an increment of 10%. As shown in FIG. 3, at a low aqueous phase fraction of 10%, Example 5H did not form an emulsion, and the aqueous and non-aqueous phases remain separated. Emulsions were formed when the aqueous phase fractions increased to 20% or above. Particularly, the entire mixtures of Examples 51 and 5J were substantially emulsified when the aqueous phase fractions were between 20% and 30%. Further increasing the aqueous phase fractions caused the emulsions suspend above the aqueous phase due to their low density (Examples 5L to 5P).

### Example 6—Synthesis of Aziridine Pyridinium Salt

Pyridine (1.5 mol) and hydrochloric acid or hydrobromic acid (1 mol) were added to a round bottom flask and purged with nitrogen, and stirred at room temperature (25° C.) for 10 min. Then, 1 mole of solvent (MEG or DGME or 2-butoxyethanol) was added, followed by adding (Aziridine-2-yl) methanol) (1 mol), to the first flask or vessel and again stirred for 30 min and heated at 100° C. for 10 hours. At the end of the elapsed time, sample was collected for 1H-NMR analysis. At the end of experiment, pyridinium salt of aziridine in respective solvent was collected and additional analysis and characterization was carried out.

In case of water was used as solvent, at the end of experiment, sample was freeze dried to remove the water. A general reaction scheme is shown in Reaction Scheme #4.

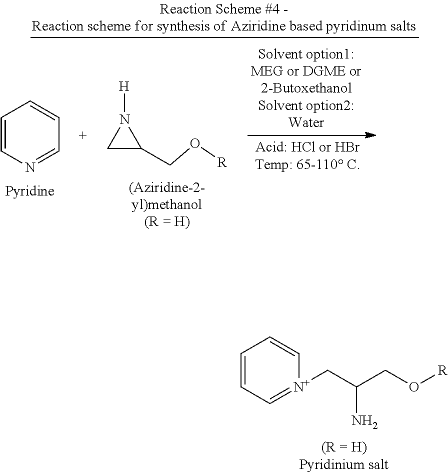

### Example 7—Synthesis of Thiirane Pyridinium Salt

Pyridine (1.5 mol) and hydrochloric acid or hydrobromic acid (1 mol) were added to a round bottom flask and purged with nitrogen, and stirred at room temperature (25° C.) for 10 min. Then, 1 mole of solvent (MEG or DGME or 2-butoxyethanol) was added, followed by adding 2-(Methoxymethyl) thiirane (1 mol), to the first flask or vessel and again stirred for 30 min and heated at 100° C. for 10 hours. At the end of the elapsed time, sample was collected for 1H-NMR analysis. At the end of experiment, pyridinium salt of thiirane in respective solvent was collected and additional analysis and characterization was carried out.

In case of water was used as solvent, at the end of experiment, sample was freeze dried to remove the water. A general reaction scheme is shown in Reaction Scheme #5.

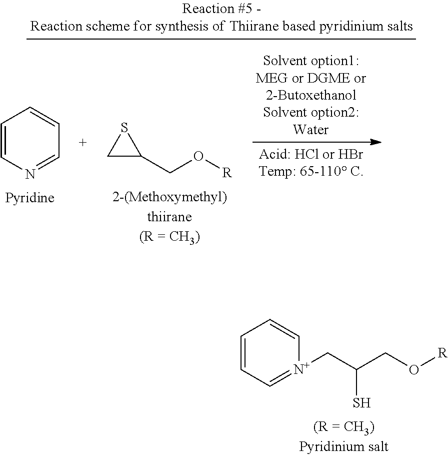

As demonstrated at least through the Examples herein, pyridinium-based compound emulsifiers disclosed herein are capable of forming emulsions at a concentration significantly lower than commercial available emulsifiers and at a low aqueous phase fraction. Moreover, emulsions comprising a pyridinium-based compound disclosed herein as the emulsifier exhibit great stability and versatility across a wide range of emulsifier concentration and aqueous phase fractions, making them suitable for petroleum industry applications.

Numerous aspects of the present application are described hereinbelow as Aspects 1-20.

Aspect 1. An emulsion, comprising an aqueous phase comprising an aqueous base fluid; a non-aqueous phase comprising hydrocarbons; and an emulsifier that is a pyridinium-based compound having the structure:

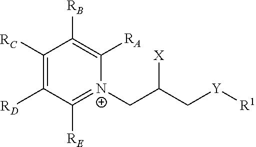

or a salt thereof, wherein: X is —CH₃, —OH, —NH₂, or —SH; Y is —CH₂—, —O—, —NR²—, or —S—, excluding where X is —CH₃ and Y is —CH₂—; R¹ is a C₁-C₁₈ alkyl group, a C₁-C₁₈ hydroxyl alkyl group, a C₁-C₁₈ alkenyl group, a C₁-C₁₈ internal alkynyl group, a C₁-C₁₈ acryl group, a C₁-C₁₈ cycloalkyl group, or a C₁-C₁₈ functional alkyl group; and each of R², R_{A}, R_{B}, R_{C}, R_{D}, and R_{E} is chosen from hydrogen, a C₁-C₁₈ alkyl group, a C₁-C₁₈ hydroxyl alkyl group, a C₁-C₁₈ alkenyl group, a C₁-C₁₈ alkynyl group, a C₁-C₁₈ acryl group, a C₁-C₁₈ cycloalkyl group, or a C₁-C₁₈ functional alkyl group.

Aspect 2. The emulsion of aspect 1, wherein the aqueous phase is a continuous phase and wherein the non-aqueous phase is dispersed in the continuous phase.

Aspect 3. The emulsion of aspect 1, wherein the non-aqueous phase is a continuous phase and wherein the aqueous phase is dispersed in the continuous phase.

Aspect 4. The emulsion of any one of aspects 1 to 3, wherein the aqueous phase comprises greater than or equal to 15 vol. % and less than or equal to 40 vol. % of the total volume of the emulsion; and the non-aqueous phase comprises greater than or equal to 60 vol % and less than or equal to 85 vol. % of the total volume of the emulsion.

Aspect 5. The emulsion of any one of aspects 1 to 4, wherein the emulsifier is in an amount that is greater than or equal to 500 ppm and less than or equal to 1,500 ppm of the total weight of the emulsion.

Aspect 6. The emulsion of any one of aspects 1 to 5, wherein the emulsifier has a Critical Micelle Concentration (CMC) that is greater than or equal to 100 parts per million (ppm) and less than or equal to 500 ppm of the total weight of the emulsion, as measured at a water-air interface.

Aspect 7. The emulsion of any one of aspects 1 to 6, wherein X is —OH.

Aspect 8. The emulsion of any one of aspects 1 to 6, wherein Y is —O—.

Aspect 9. The emulsion of any one of aspects 1 to 6, wherein X is —OH; and Y is —O—.

Aspect 10. The emulsion of any one of aspects 1 to 9, wherein R_{A}, R_{B}, R_{C}, R_{D}, and R_{E} are each hydrogen.

Aspect 11. The emulsion of any one of aspects 1 to 10, wherein R¹ is a C₁-C₁₈ alkyl group.

Aspect 12. The emulsion of any one of aspects 1 to 11, wherein the emulsion has a temperature that is greater than or equal to 25° C. and less than or equal to 150° C.

Aspect 13. The emulsion of any one of aspects 1 to 12, wherein the aqueous base fluid has a pH value that is greater than or equal to 6 and less than or equal to 9.

Aspect 14. The emulsion of any one of aspects 1 to 13, wherein the aqueous base fluid has a salinity that is less than or equal to 150 gram per liter (g/L).

Aspect 15. The emulsion of any one of aspects 1 to 14, wherein the emulsion is present in a downhole environment where hydrocarbons are being extracted.

Aspect 16. The emulsion of any one of aspects 1 to 14, wherein the emulsion is present in a pipeline transporting hydrocarbons.

Aspect 17. The emulsion of any one of aspects 1 to 14, wherein the emulsion is present in a tank housing hydrocarbons during tank cleaning.

Aspect 18. A method for extracting hydrocarbons in a downhole environment, the method comprising utilizing the emulsion of any one of aspects 1 to 14.

Aspect 19. A method for transporting hydrocarbons in a pipeline, the method comprising utilizing the emulsion of any one of aspects 1 to 14.

Aspect 20. A method for cleaning a tank housing hydrocarbons comprising utilizing the emulsion of any one of aspects 1 to 14.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

All numerical ranges herein expressed in the format “from X to Y” are to be interpreted as including the endpoints X and Y and all numbers between the endpoints.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

1. An emulsion comprising:
an aqueous phase comprising an aqueous base fluid;
a non-aqueous phase comprising hydrocarbons; and
an emulsifier that is a pyridinium-based compound having the structure: 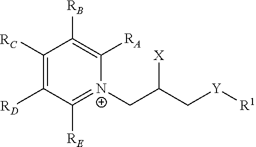
or a salt thereof, wherein:
X is —CH₃, —OH, —NH₂, or —SH;
Y is —CH₂—, —O—, —NR²—, or —S—, excluding where X is —CH₃ and Y is —CH₂—;
R¹ is a C₁-C₁₈ alkyl group, a C₁-C₁₈ hydroxyl alkyl group, a C₁-C₁₈ alkenyl group, a C₁-C₁₈ internal alkynyl group, a C₁-C₁₈ acryl group, a C₁-C₁₈ cycloalkyl group, or a C₁-C₁₈ functional alkyl group; and
each of R², R_{A}, R_{B}, R_{C}, R_{D}, and R^{E} is chosen from hydrogen, a C₁-C₁₈ alkyl group, a C₁-C₁₈ hydroxyl alkyl group, a C₁-C₁₈ alkenyl group, a C₁-C₁₈ alkynyl group, a C₁-C₁₈ acryl group, a C₁-C₁₈ cycloalkyl group, or a C₁-C₁₈ functional alkyl group.

2. The emulsion of claim 1, wherein the aqueous phase is a continuous phase and wherein the non-aqueous phase is dispersed in the continuous phase.

3. The emulsion of claim 1, wherein the non-aqueous phase is a continuous phase and wherein the aqueous phase is dispersed in the continuous phase.

4. The emulsion of claim 1, wherein:
the aqueous phase comprises greater than or equal to 15 vol. % and less than or equal to 40 vol. % of the total volume of the emulsion; and
the non-aqueous phase comprises greater than or equal to 60 vol % and less than or equal to 85 vol. % of the total volume of the emulsion.

5. The emulsion of claim 1, wherein the emulsifier is in an amount that is greater than or equal to 500 ppm and less than or equal to 1,500 ppm of the total weight of the emulsion.

6. The emulsion of claim 1, wherein the emulsifier has a Critical Micelle Concentration (CMC) that is greater than or equal to 100 parts per million (ppm) and less than or equal to 500 ppm of the total weight of the emulsion, as measured at a water-air interface.

7. The emulsion of claim 1, wherein X is —OH.

8. The emulsion of claim 1, wherein Y is —O—.

9. The emulsion of claim 7, wherein X is —OH; and Y is —O—.

10. The emulsion of claim 1, wherein R_{A}, R_{B}, R_{C}, R_{D}, and R^{E} are each hydrogen.

11. The emulsion of claim 1, wherein R¹ is a C₁-C₁₈ alkyl group.

12. The emulsion of claim 1, wherein the emulsion has a temperature that is greater than or equal to 25° C. and less than or equal to 150° C.

13. The emulsion of claim 1, wherein the aqueous base fluid has a pH value that is greater than or equal to 6 and less than or equal to 9.

14. The emulsion of claim 1, wherein the aqueous base fluid has a salinity that is less than or equal to 150 gram per liter (g/L).

15. The emulsion of claim 1, wherein the emulsion is present in a downhole environment where hydrocarbons are being extracted.

16. The emulsion of claim 1, wherein the emulsion is present in a pipeline transporting hydrocarbons.

17. The emulsion of claim 1, wherein the emulsion is present in a tank housing hydrocarbons during tank cleaning.

18. A method of using an emulsion, wherein the emulsion is the emulsion of claim 1, and wherein the method comprises:
extracting hydrocarbons in a downhole environment;
transporting hydrocarbons in a pipeline; or
cleaning a tank housing hydrocarbons.
